(19) United States
(12) Patent Application Publication
(10) Pub. No.: US 2025/0199164 A1
(43) Pub. Date: Jun. 19, 2025

(54) RADAR-BASED PARKING OCCUPANCY SENSOR

(71) Applicant: ST ENGINEERING URBAN SOLUTIONS LTD., Singapore (SG)

(72) Inventors: Bernard Peng Peng LEE, Singapore (SG); Ray FANG, Singapore (SG); Mohammad Jaleel SOREEFAN, Singapore (SG); Yuan DAO, Singapore (SG); Guangming SU, Singapore (SG)

(73) Assignee: ST ENGINEERING URBAN SOLUTIONS LTD., Singapore (SG)

(21) Appl. No.: 18/851,646

(22) PCT Filed: Aug. 29, 2023
(86) PCT No.: PCT/SG2023/050590

§ 371 Date: Sep. 26, 2024

(30) Foreign Application Priority Data
Sep. 1, 2022 (SG) 10202250879A

(51) Int. Cl. G01S 13/91; G01S 7/35; G01S 13/04; G08G 1/01

(52) U.S. Cl. CPC G01S 13/91; G01S 7/356; G01S 13/04; G08G 1/0133

(57) ABSTRACT

This invention relates to a system for contactless detection and provision on an occupancy status parking lots in at least one vehicle park. A system comprises a frontend sensor unit having a number of radar modules and a detection board. Each of the radar modules comprises a transmitter configured to transmits L consecutive frequency modulated chirps and at least 3 receivers configured to collect the return chirps. The detection board is adapted to control and receive data from each of the radar modules and executing processes to analyse the data received from the radar modules to determine occupancy status of parking lots.

### FIELD OF THE INVENTION

This invention relates to a system and method of detecting and providing an occupancy status of multiple parking lots. Particularly, this invention relates to a system and method detecting and providing an occupancy status of multiple parking lots using at least one sensor to detect presence vehicles and communicate the information wirelessly to a backend server.

### PRIOR ART

Current technology used in parking occupancy sensing includes the use of low-cost ultrasonic sensors, laser or Time-of-Flight (TOF) sensors, and cameras. Ultrasonic and TOF-based sensors are usually deployed to detect the occupancy of one parking lot per sensor. While the individual sensors are low in cost, extensive cabling infrastructure is necessary for power and signal delivery and hence, costly and unsightly. Laser-based sensors also tend to degrade over time as dirt and dust accumulates on their lens, affecting accuracy.

The most recent advances are in camera-based solutions. It is possible to detect the occupancy of three parking lots per unit and infrastructure is reduced. However, the camera is costly and its accuracy is easily affected by changes in lighting conditions (i.e., near carpark openings, sudden dim conditions), the color of the vehicle (i.e., black) and the cleanliness of the lens. In addition, power consumption of such devices is high, and is operationally expensive over time. It can also be a cause for privacy concerns.

Therefore, those skilled in the art are striving to provide a sustainable system and/or a method that allows monitoring occupancy of parking spaces.

### SUMMARY OF THE INVENTION

The above and other problems are solved and an advance in the state of the art is made by a system and method in accordance with this invention. A first advantage of the system and method in accordance with this invention is the ability to monitor a few parking lots with one sensor unit. A second advantage of the system and method in accordance with this invention is that the system and method uses radar based sensors which is not affected by changes in the surrounding environment, i.e. light levels and temperature.

A first aspect of the disclosure describes a system for contactless detection and provision on an occupancy status in at least one vehicle lot. The system comprises a frontend sensor unit including a plurality of radar modules and a detection board. Each of the radar modules comprises a transmitter configured to transmits L consecutive frequency modulated chirps and at least 3 receivers configured to collect the return chirps. The detection board is adapted to control and receive data from each of the radar modules and executing processes to analyse the data received from the radar modules to determine occupancy status of parking lots.

In one embodiment of the first aspect of the disclosure, the at least 3 receivers are arranged such that the second receiver (RX2) is a reference, the first receiver (RX1) is located laterally to RX2 and the third receiver (RX3) is located longitudinally to RX2.

In one embodiment of the first aspect of the disclosure, the processes to analyse the data received from the radar modules to determine occupancy status of parking lots comprise instructions to: initialise the plurality of radar modules; receive L return chirps from one of the plurality of radar modules; capture a time domain data of each of the L return chirps; translate the time domain data of the L return chirps to frequency domain by applying Fast=Fourier transform (FFT) to form one frame of FFT data, each FFT data comprises amplitude, frequency and phase data; apply a thresholding algorithm to the FFT data to determine valid peaks; and convert FFT data into ranges and phases.

In one embodiment of the first aspect of the disclosure, the transmitter is configured to transmit a frequency modulated (FM) chirp over a 2 GHz bandwidth.

In one embodiment of the first aspect of the disclosure, the processes to analyse the data received from the radar modules to determine occupancy status of parking lots comprise instructions to: initialize position of each parking lot to determine boundary parameter of the parking lot, the boundary parameter includes maximum and minimum radial distance (r), maximum and minimum bearing (θ) and maximum and minimum vehicle height (z).

In one embodiment of the first aspect of the disclosure, the one frame of FFT data comprises N sequential frequency bins of Fmax/N frequency resolution and each frequency bin represents a range, R, having a resolution of Rmax/N and the radial range of obstacles in the radar's field of view presents is a beat frequency with a relationship in a following expression:

$$R = ( c\_oTf \_b ) / 2 Δ f$$

where R=radial distance between the radar and the target, co=speed of light, 3×108, Δf=frequency bandwidth, T=time needed to modulate the frequency, f_b=beat frequency.

In one embodiment of the first aspect of the disclosure, the processes to analyse the data received from the radar modules to determine occupancy status of parking lots comprise instructions to: determine cylindrical coordinates (r, θ, z) of each of each FFT data with the following expressions,

r=R;

$$θ = {sin}^{- 1} ( \frac{Δ ϕ λ}{2 π d} )$$

where ΔØ=phase difference between RX1 and RX2, d=distance between RX1 and RX2 and λ=wavelength of transmit frequency in free space; and

$$z = r sin ( {sin}^{- 1} ( \frac{Δ ϕ λ}{2 π d} ) )$$

where ΔØ=phase distance between RX2 and RX3 and d=distance between RX2 and RX3 and λ=wavelength of transmit frequency in free space.

In one embodiment of the first aspect of the disclosure, the processes to analyse the data received from the radar modules to determine occupancy status of parking lots comprise instructions to: apply a Density-based spatial clustering of applications with noise (DBSCAN) on the cylindrical coordinates to form distinct clusters; and determine occupancy status of a parking lot if the distinct clusters are within the boundary parameter of the parking lot for a predetermined number of frames.

In one embodiment of the first aspect of the disclosure, the instruction to determine occupancy status of a parking lot if the distinct clusters are within the boundary parameter of the parking lot for a predetermined number of frames comprises instructions to: select a cluster from the distinct clusters and compute an average position r_{avgci}, θ_{avgci}, z_{avgci} of the selected cluster, where avgc refers to average over L chirps; compares the average position of the selected cluster with boundary conditions corresponding to the parking lot of the selected cluster; in response to the average position of the selected cluster being within the boundary conditions corresponding to the parking lot of the selected cluster, accumulate the cylindrical coordinates of the selected cluster and store in “LotCount” folder where “LotCount” folder contains the number of clusters for the corresponding parking lot; and in response to the average position of the selected cluster being outside the boundary conditions corresponding to the parking lot of the selected cluster, disregard the cylindrical coordinates of the selected cluster.

In one embodiment of the first aspect of the disclosure, the instruction to accumulate the cylindrical coordinates of the selected cluster and store in “LotCount” folder where “LotCount” folder contains the number of clusters for the corresponding parking lot further comprises instructions to: determines if the number of clusters for the corresponding parking lot is more than a predetermined number of clusters; in response to the number of clusters for the corresponding parking lot being more than a predetermined number of clusters, change a lotOccupancy[i][j] from zero to one and apply an adaptive algorithm to check boundary conditions of the corresponding parking lot, where [i] refers to sector number and [j] refers to parking lot number.

In one embodiment of the first aspect of the disclosure, the instruction to apply an adaptive algorithm to check boundary conditions of the corresponding parking lot comprises instructions to: averages the position (r_{avgfn}, θ_{avgfn}, z_{avgfn}) of the selected cluster over a number of frames with previous position (r_{avgfn-1}, θ_{avgfn-1}, z_{avgfn-1}) to obtain a new average position (r_{avgf}, θ_{avgf}, z_{avgf}), where avgf refers to average over a number of frames; and in response to new average position (r_{avgf}, θ_{avgf}, z_{avgf}) is out of reference position (r_{ref}, θ_{ref}, z_{ref}), update boundary conditions for the corresponding parking lot with a fixed pre-defined value to shift boundary conditions closer to new average position.

In one embodiment of the first aspect of the disclosure, the instruction to determine occupancy status of a parking lot if the distinct clusters is within the boundary parameter of the parking lot for a predetermined number of frames further comprises instructions to: evaluate lot occupancy information for the corresponding parking lot each frame (n) and sector (i); in response to LotOccupancy(i)(j)=1, increment frameOccupancy(i)(j); and in response to frameOccupancy(i)(j) being is equal to or more than a predetermined threshold, determined parking lot (j) as occupied.

In one embodiment of the first aspect of the disclosure, the predetermined threshold is 8.

### BRIEF DESCRIPTION OF THE DRAWINGS

The above and other features and advantages in accordance with this invention are described in the following detailed description and are shown in the following drawings:

FIG. 1 illustrating an overview of the architecture of the system in accordance with an embodiment of this disclosure;

FIG. 2 illustrating a block diagram of a processing unit in accordance with an embodiment of this disclosure;

FIG. 3 illustrating an architecture of the frontend sensor in accordance with an embodiment of this disclosure;

FIG. 4.1 illustrating a perspective view the frontend sensor with a housing in accordance with an embodiment of this disclosure;

FIG. 4.2 illustrating a bottom view of the frontend sensor unit in accordance with an embodiment of this disclosure;

FIG. 4.3 illustrating a top view of the frontend sensor unit in accordance with an embodiment of this disclosure;

FIG. 4.4 illustrating a side view of the frontend sensor unit in accordance with an embodiment of this disclosure;

FIG. 5.1 illustrating the arrangement of the transmitter and receivers of a radar module unit in accordance with an embodiment of this disclosure;

FIG. 5.2 illustrating the frontend sensor being installed in a vehicle park in accordance with an embodiment of this disclosure;

FIG. 6.1 illustrating a first arrangement where the frontend sensors are being installed in a vehicle park and each frontend sensor monitors 6 parking lots in accordance with an embodiment of this disclosure;

FIG. 6.2 illustrating a second arrangement where the frontend sensors are being installed in a vehicle park and each frontend sensor monitors 6 parking lots in accordance with an embodiment of this disclosure;

FIG. 6.3 illustrating a third arrangement where the frontend sensors are being installed in a vehicle park and each frontend sensor monitors 3 parking lots in accordance with an embodiment of this disclosure;

FIG. 6.4 illustrating a fourth arrangement where the frontend sensors are being installed in a vehicle park and each frontend sensor monitors 3 parking lots in accordance with an embodiment of this disclosure;

FIG. 6.5 illustrating a fifth arrangement where the 2 frontend sensors are being installed in a vehicle park where one is monitoring 12 parking lots and the other is monitoring 6 parking lots in accordance with an embodiment of this disclosure;

FIG. 7 illustrating a process flow being executable by a processing unit of the frontend sensor in accordance with an embodiment of this disclosure;

FIG. 8 illustrating the transmitted signal (in bold line) and received signal (in dotted line of a frontend sensor in accordance with an embodiment of this disclosure;

FIG. 9.1 illustrating the received signal from 3 receive antennas (RX1, RX2, RX3) from one chirp which have been translated into FFT data in accordance with an embodiment of this disclosure;

FIG. 9.2 illustrating the clustering of data in accordance with an embodiment of this disclosure; and

FIG. 10 illustrating a process flow being executable by a processing unit of the detector board to determine vacancy of parking lots being monitored by each radar sensor in accordance with an embodiment of this disclosure.

### DETAILED DESCRIPTION

This invention relates to a system and method of detecting and providing an occupancy status of multiple parking lots. Particularly, this invention relates to a system and method detecting and providing an occupancy status of multiple parking lots using at least one sensor to detect presence vehicles and communicate the information wirelessly to a backend server.

It is envisioned that a system and method in accordance with embodiments of this invention may be used for determining occupancy of parking spaces in multiple vehicle parks. The system and method utilise radar-based sensors to monitor and determine occupancy of parking lots. As the system and method utilise radar-based sensors as opposed to camera sensors, there would not no issues with privacy invasion.

The system and method in accordance with embodiments of this invention is capable of contactlessly detecting and providing the occupancy status of multiple parking lots (up to 16 lots) with a single frontend sensor unit. This frontend sensor unit would communicate the information through wire or wirelessly means to a backend server. This results in significant costs reduction in the infrastructure, deployment, maintenance and on-going operations. As the number of occupancy indicator nodes are also significantly reduced, drivers are less distracted and each indicator is more visible. It can also be flexibly deployed in a variety of parking scenarios, not limited to vertical, parallel and diagonal lots, and robust to environmental variations.

In addition, unlike ultrasonic, laser and imaging technologies, radar technology can detect lot occupancy in harsher environments such as snow and rain. This enables the possibility of using this technology for outdoor parking occupancy detection. This includes open air and roadside parking spaces.

Furthermore, this frontend sensor unit utilises 3D radar sensors, it provides radar images of the objects in its view. Thus, it has the ability to broadly classify the type of object in each lot (i.e., sedan, van, truck, motorbike, obstacle, trolley, human) for data analytics and enforcement.

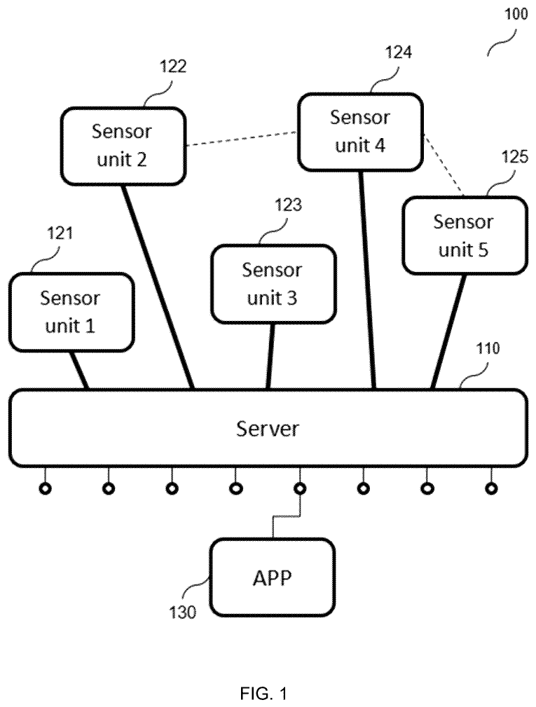

FIG. 1 shows an overview of the architecture of the system 100 in accordance with an embodiment of this invention. The system 100 includes a backend server 110, a number of frontend sensor units 121-125 and an application 130. Further, more than one application 130 may be provided.

Servers or computing systems executing processes of the backend server 110 are typical processing systems such as a desktop computer, laptop computer, or other computer terminal that are communicatively connected to each other via a network via either a wired or wireless connection. Servers or computing systems executes applications necessary to perform the functions of the backend server 110 in accordance with this disclosure.

Frontend sensor units 121-125 may be installed in the same vehicle park. In such arrangement, only one backend server 110 is required. In another embodiment, the frontend sensor units 121-125 may be installed in different vehicle parks. For example, frontend sensor units 121 and 122 may be installed in vehicle park 1 while frontend sensor units 123-125 may be installed in vehicle park 2. In such arrangement, two sub-servers may be required, where one sub-server is installed in vehicle park 1 to handle data from frontend sensor units 121 and 122 and another sub-server is installed in vehicle park 2 to handle data from frontend sensor units 123-125. Hence, one skilled in the art will recognise that more than 5 frontend sensor units 121-125 may be connected to the backend server 110 without departing from the invention. Further, one skilled in the art will also recognise that a sub-server may be introduced at each vehicle park to handle data from frontend sensor units in the same vehicle park to bridge communication with the backend server 110 without departing from the invention.

The backend server 110 provides access to third party application 130 through Application Programming Interfaces (APIs) 111. Third party application 130 is any servers or computing systems that is able to access data through the APIs 111 provided by the backend server 110. Some information that may be provided by the backend server 110 through the APIs 111 includes, number of available parking lots in each monitor vehicle park, cost of parking vehicle in the monitored vehicle park, etc.

The servers or computing systems executing the applications necessary to perform the functions of the backend server 110 and sub-servers are communicatively connected to each other via a network such as the Internet that allows various servers and computing systems to communicate with one another.

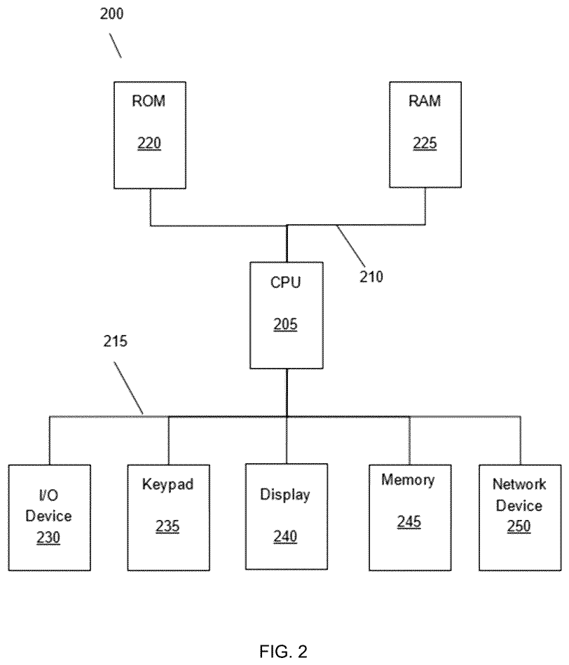

Processes are stored as instructions in a media that are executed by a processing system in servers, computing systems or virtual machines running on the servers or computing systems to provide the method and/or system in accordance with this disclosure. The instructions may be stored as firmware, hardware, or software. FIG. 2 illustrates processing system 200 such as the processing system in servers or computing systems that execute the instructions to perform the processes of the backend server 110 and sub-servers. One skilled in the art will recognize that the exact configuration of each processing system may be different and the exact configuration of the processing system in each device may vary. Thus, processing system 200 shown in FIG. 2 is given by way of example only.

Processing system 200 includes Central Processing Unit (CPU) 205. CPU 205 is a processor, microprocessor, or any combination of processors and microprocessors that execute instructions to perform the processes in accordance with the present invention. CPU 205 connects to memory bus 210 and Input/Output (I/O) bus 215. Memory bus 210 connects CPU 205 to memories 220 and 225 to transmit data and instructions between the memories and CPU 205. I/O bus 215 connects CPU 205 to peripheral devices to transmit data between CPU 205 and the peripheral devices. One skilled in the art will recognize that I/O bus 215 and memory bus 210 may be combined into one bus or subdivided into many other busses and the exact configuration is left to those skilled in the art.

A non-volatile memory 220, such as a Read Only Memory (ROM), is connected to memory bus 210. Non-volatile memory 220 stores instructions and data needed to operate various sub-systems of processing system 200 and to boot the system at start-up. One skilled in the art will recognize that any number of types of memory may be used to perform this function.

A volatile memory 225, such as Random Access Memory (RAM), is also connected to memory bus 210. Volatile memory 225 stores the instructions and data needed by CPU 205 to perform software instructions for processes such as the processes required for providing a system in accordance with this invention. One skilled in the art will recognize that any number of types of memory may be used as volatile memory and the exact type used is left as a design choice to those skilled in the art.

I/O device 230, keyboard 235, display 240, memory 245, network device 250 and any number of other peripheral devices connect to I/O bus 215 to exchange data with CPU 205 for use in applications being executed by CPU 205. I/O device 230 is any device that transmits and/or receives data from CPU 205. Keyboard 235 is a specific type of I/O that receives user input and transmits the input to CPU 205. Display 240 receives display data from CPU 205 and display images on a screen for a user to see. Memory 245 is a device that transmits and receives data to and from CPU 205 for storing data to a media. Network device 250 connects CPU 205 to a network for transmission of data to and from other processing systems.

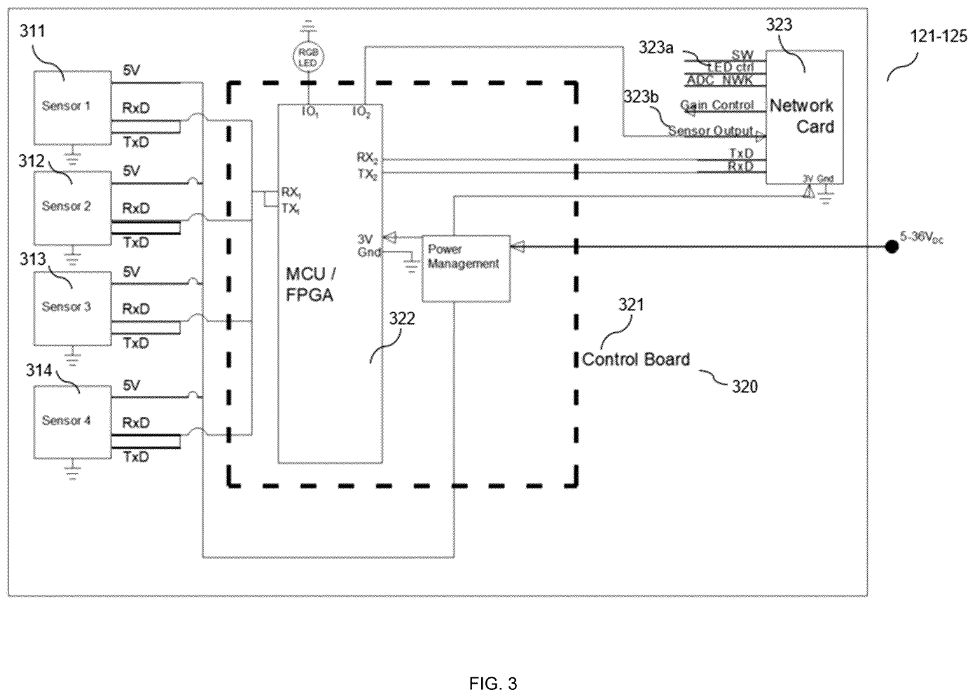

FIG. 3 shows an architecture of each frontend sensor unit 121-125. Each frontend sensor unit 121-125 comprises 4 radar modules 311-314 and a detector board 320. The 4 radar modules 311-314 are any commercially available radar sensors such as MP555 radar sensor. The MP555 radar sensor uses an onboard mm-wave radar chip with 1 transmitter (TX) and 3 receivers (RX) to obtain target information in 3 dimensions: range, azimuth angle and elevation angle. One skilled in the art will recognise that other models of radar sensors may be implemented without departing from the invention as long as the radar sensor is able to obtain target information in 3 dimensions.

The detector board 320 comprises an On Demand Regulator (ODR) 321 interfaced by a Universal Asynchronous Receiver-Transmitter (UART) port 322 and a network card 323. For purposes of this invention, the UART port 322 is implemented using a microcontroller unit (MCU). The model of the MCU is STM32F051C8. One skilled in the art will recognise that other models of MCU may be implemented without departing from the invention. Essentially, the detection board 320 is capable of controlling and receiving data from the radar modules 311-314, and executing processes to analyse the data received from the radar modules 311-314 to determine occupancy of one or more parking lots.

The UART ports 322 are typically interfaced on a 1 device to 1 UART port basis. If they are daisy chained as shown in FIG. 3, they will collide and data transfer will fail. However, this issue can be circumvented by polling the 4 radar modules 311-314 for occupancy data. Each time the ODR 320 polls 1 data from one of the 4 radar modules 311-314, the other 3 radar modules are put to sleep mode. This simplifies the hardware, reduces costs, reduces overall power consumption, and reduces the requirements on the number of UART ports on the MCU.

Each radar module 311-314 comprises a transmitter to transmit (TX) L consecutive frequency modulated (FM) chirps over a 2 GHz bandwidth. During each chirp, each receiver collects the return chirps and performs fast-fourier transforms (FFT) over the K RX channels, to identify valid targets. One skilled in the art will recognise that other numbers of chirps may be implemented without departing from the invention. However, it is observed that 8 consecutive frequency modulated (FM) chirps over a 2 GHz bandwidth provides an accurate result. The returns are accumulated and their distance and angle in the azimuth and elevation, computed. This information is then output to the sensor output 323b of the network card 323 which will in turn transmit the information to the server 110. The network card 323 is similar to the network device 250 in that it is use for connecting the radar module to a network for transmission of data to and from other processing systems via either wired or wireless connection means. The network card 323 will also light up the LED 323a which is a light indicator accordingly. For example, if all the parking lots being monitored by the frontend sensor unit are occupied, the network card 323 will trigger the Red LED and if one of more parking lots being monitored by the frontend sensor unit are unoccupied, the network card 323 will trigger the Green LED. One skilled in the art will recognise that colours other than green and red may be implemented without departing from the invention. Furthermore, one skilled in the art will recognise that other numbers of RX channels may be implemented without departing from the invention.

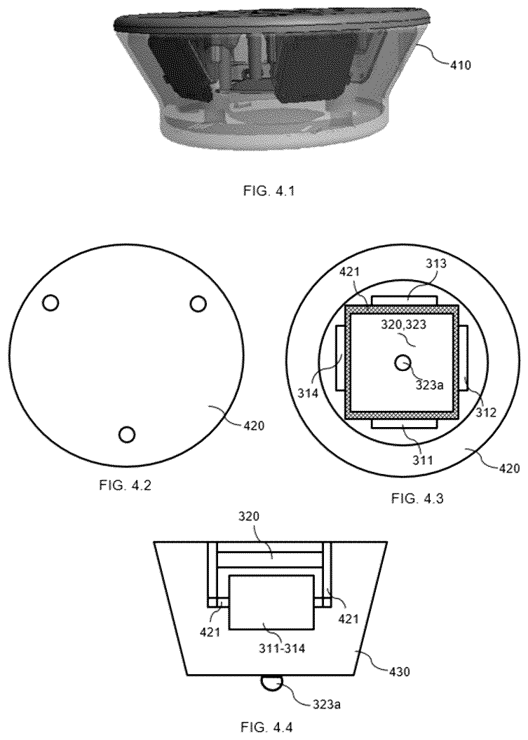

FIGS. 4.1 to 4.5 show the arrangement of the radar modules 311-314 and a detector board detector board 320 housed within a housing 410 of a frontend sensor unit. Specifically, FIG. 4.1 shows a perspective view of the frontend sensor unit; FIG. 4.2 shows a bottom view of the frontend sensor unit; and FIG. 4.3 shows a top view of the frontend sensor unit; FIG. 4.4 shows a side view of the frontend sensor unit. The housing includes a base 420 with a bracket 421 for installation to a base such as the ceiling and a cover 430. The radar modules 311-314 and a detector board detector board 320 are mounted on an internal surface of the base 420. A mounting bracket 421 is provided to secure the 4 radar modules 311-314 to the internal surface of the base 420 and allow adjustments of the 4 radar modules 311-314 in order to adjust respective field of view.

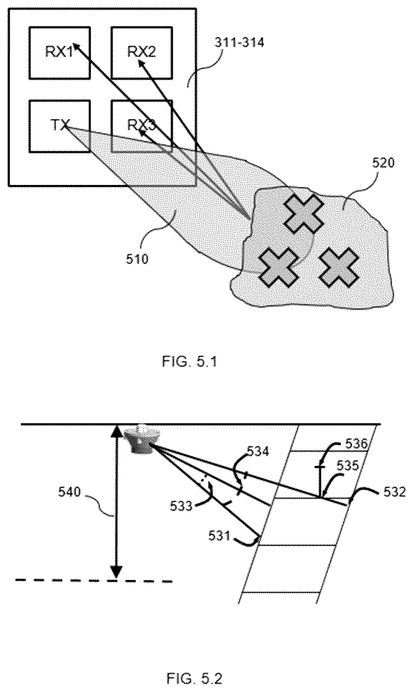

As radars have a limited field of view, usually less than 90° in the azimuth and elevation planes, we position 4, 3D radars in 4 quadrants, angled at approximately 40° to 60° towards the ground, housed in a single enclosure, for omnidirectional coverage. The parking occupancy detector, also housed within the same enclosure, provides the necessary intelligence to decipher the information from the 3D radars, decide occupancy status and provides the necessary peripheral support features for communications and light indication. This is sufficient to provide detection of up to 16 vehicle lots around the sensor when mounted from the ceiling at the centre of the driveway, 2 to 4 metres from the ground, as illustrate in FIG. 5.2.

FIGS. 5.1 and 5.2 shows the arrangement of the transmitter and receivers of a radar module 311-314. A minimum of 3 receivers (RX1, RX2 and RX3) are needed for each radar module, where RX2 is a reference, RX1 is located laterally to RX2 and RX3 is located longitudinal to RX2. In other words, RX1 is arranged at left or right side of RX2 while RX3 is arranged at either bottom or top of RX2. That said, one skilled in the art will recognise that more than 3 receivers can be implemented and the exact number of receivers to be implemented is left as a design choice to those skilled in the art. FIG. 5.1 shows the transmitter (TX) transmitting radar signal 510 towards the target field of view 520. The return chirps (shown by the arrows pointing towards the receivers) are received by the 3 receivers. Based on the position of the radar module 311-314 being mounted to a base of the car park, the boundary parameters can be determined. FIG. 5.2 shows the boundary parameters of a parking lot comprising minimum radial distance 531, maximum radial distance 532, minimum bearing e 533, maximum bearing e 534, minimum vehicle height 535, maximum vehicle height 536. As mentioned above, the frontend sensor unit is mounted on the ceiling which is between 2 and 4 metres 540 from the ground.

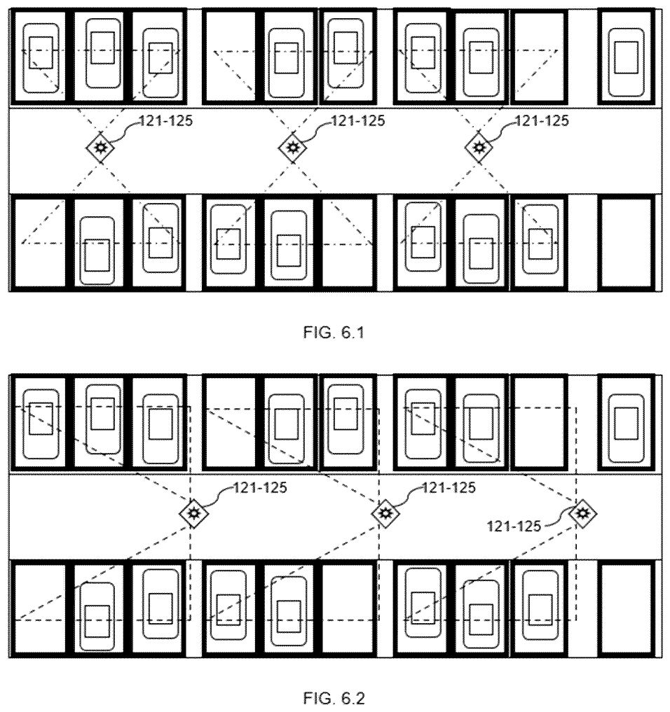

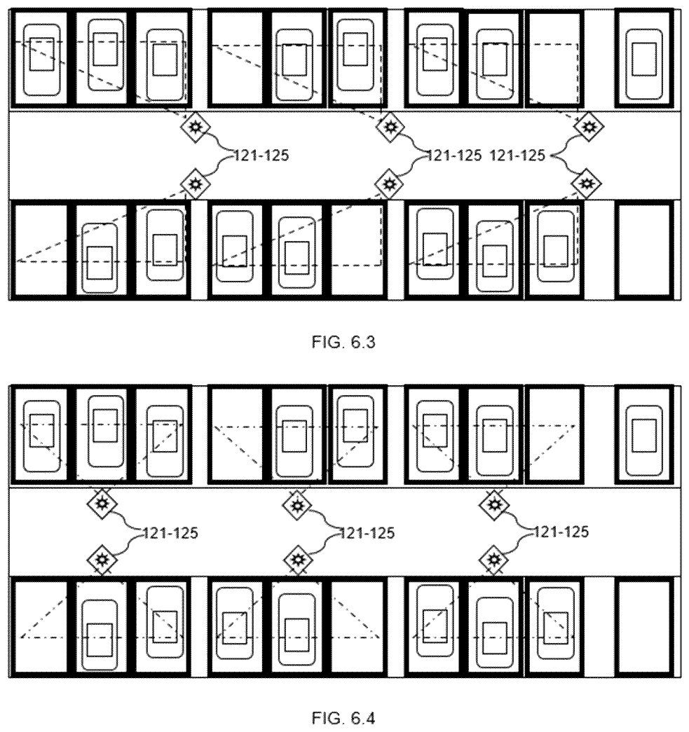

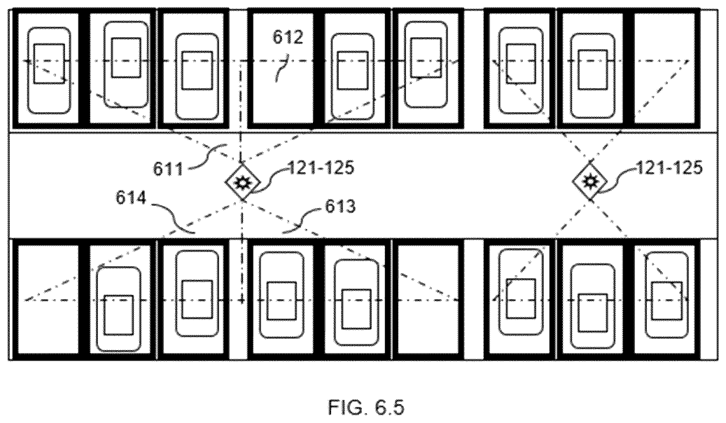

FIGS. 6.1-6.5 provides different arrangements to monitor occupancy of parking lots. Specifically, FIGS. 6.1 and 6.2 show each frontend sensor unit being able to monitor 6 parking lots. More specifically, the frontend sensor unit may be installed along a driveway and in the middle of 3 parking lots to monitor 6 parking lots (i.e. 3 parking lots on opposing sides of the driveway) as shown in FIG. 6.1. In another embodiment, the frontend sensor unit may be installed along a driveway and at one end of the 3 parking lots to monitor 6 parking lots (i.e. 3 parking lots on opposing sides of the driveway) as shown in FIG. 6.2

FIGS. 6.3 and 6.4 show each frontend sensor unit being able to monitor 3 parking lots. More specifically, the frontend sensor unit may be installed along a driveway and at one end of the 3 parking lots to monitor 3 parking lots on one side of the driveway as shown in FIG. 6.3. In another embodiment, the frontend sensor unit may be installed along a driveway and in the middle of 3 parking lots to monitor 3 parking lots on one side of the driveway) as shown in FIG. 6.4.

FIG. 6.5 shows another embodiment where a frontend sensor unit is configured to monitor 12 parking lots while another frontend sensor unit is configured to monitor 6 parking lots. Specifically, the frontend sensor unit on the left in FIG. 6.5 may be installed along a driveway and in the middle of 6 parking lots to monitor 12 parking lots (i.e. 6 parking lots on opposing sides of the driveway) while the frontend sensor unit on the right in FIG. 6.5 may be installed along a driveway and in the middle of 3 parking lots to monitor 6 parking lots (i.e. 3 parking lots on opposing sides of the driveway). As shown in FIG. 6.5, the frontend sensor unit can be easily configured to monitor different number of parking lots and the exact number of parking lots to be monitored by a single frontend sensor unit is left as a design choice to one skilled in the art. For purposes of this discussion, the optimal number of parking lots to be monitored by a single frontend sensor unit is 16 parking lots, with 8 parking lots on each side of the driveway. This is based on the use of 4 MP555 radar sensors in each frontend sensor unit.

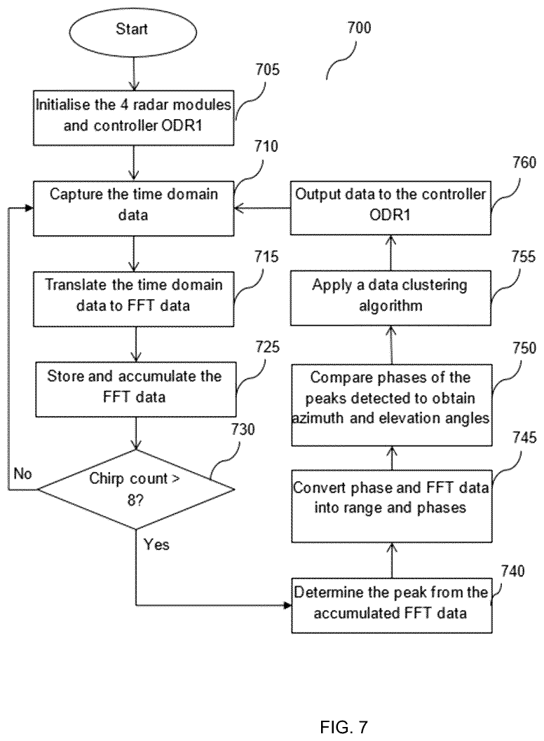

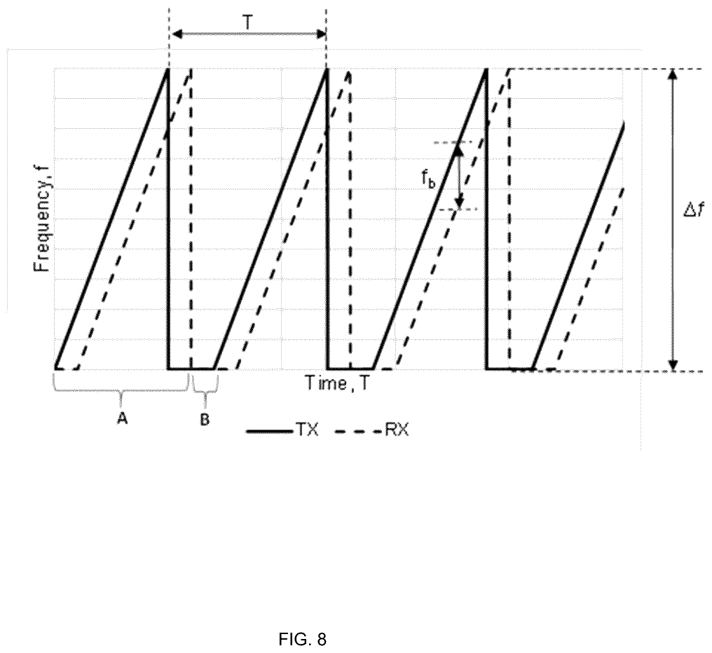

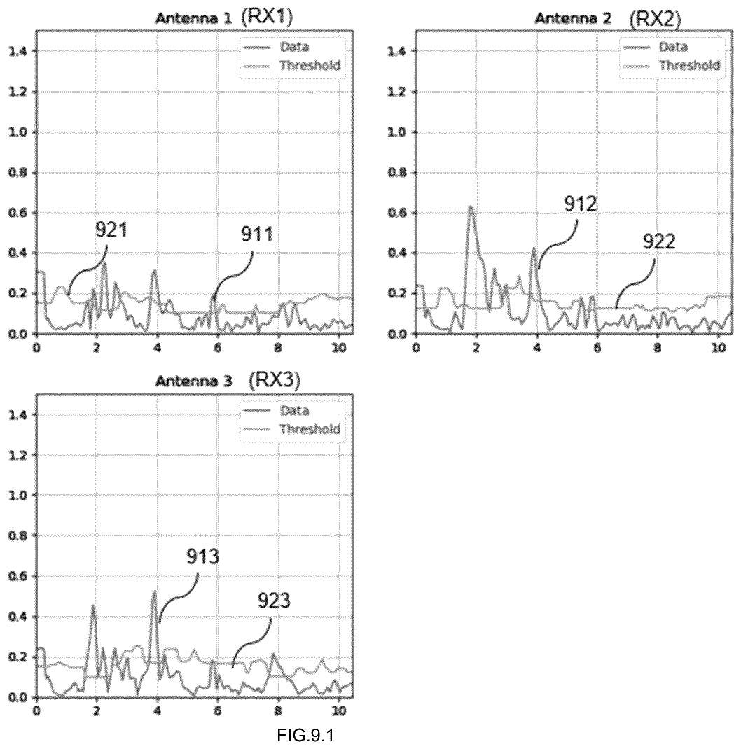

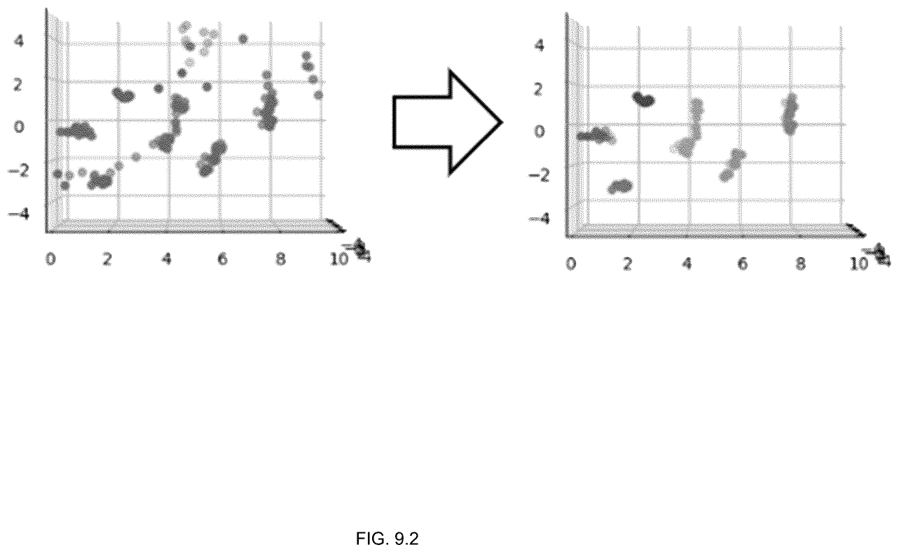

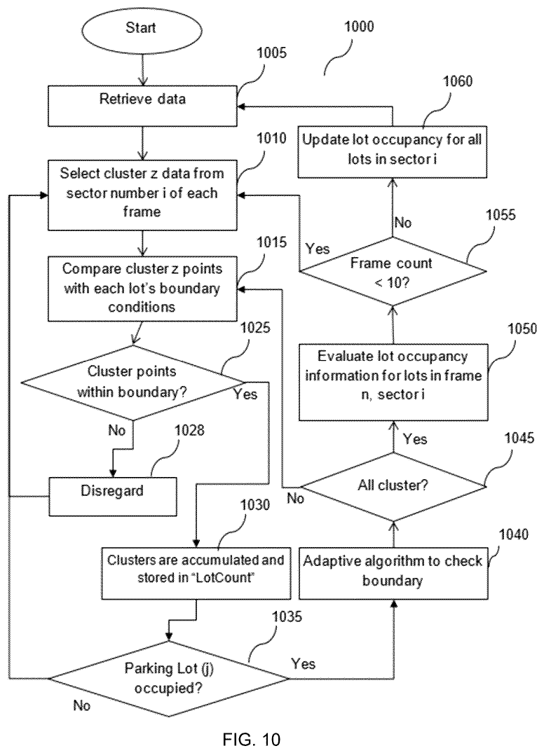

FIG. 7 illustrates a process flow 700 executed by the instructions store on the memory of the MCU 322 of the detector board 320 in accordance with an embodiment of this invention. As mentioned above, each radar module 311-314 transmits (TX) 8 consecutive frequency modulated (FM) chirps over a 2 GHz bandwidth. During each chirp, each receiver collects the returns and performs fast-fourier transforms (FFT) over the K RX channels, to identify valid targets. For purposes of this disclosure, K=3 as the radar module that has been implemented comprises 3 RX channels. That said, K can be other numbers without departing from the invention. The return chirps are accumulated and their distance and angle in the azimuth and elevation, computed by the detection board 320. This information is then output to the sensor output 323b of the network card 323 which will in turn transmit the information to the server 110. Process flow 700 corresponds to the process executed by the MCU 322 of the detector board 320 to receive the information from the radar modules 311-314, translate the information from the radar modules 311-314 to distance, angle in the azimuth and elevation, determine occupancy of parking lots, and transmitting the information to the network card 323. One skilled in the art will recognise that the MCU 322 and network card 323 may be replaced by a simple edge computer or any processing unit comprising a processor, a network device, a memory and instructions stored on the memory and executable by the processor to perform the processes of controlling and receiving data from the radar modules 311-314; translating the data from the radar modules 311-314 to distance, angle in the azimuth and elevation; determining occupancy of parking lots; and transmitting data to the server 110 via the network device. Process 700 begins with step 705 to initialise the 4 radar modules 311-314 and the controller ODR 321. In response, the one of the 4 radar modules 311-314 transmits and receives FM chirps. Specifically, a selected radar module 311-314 transmits (TX) a frequency modulated (FM) chirp over a 2 GHz bandwidth and receive the return FM chirps from each of the K RX channels of the selected radar module 311-314. FIG. 8 illustrates the transmitted signal (in bold line) and received signal (in dotted line). Specifically, each of the 4 radar modules 311-314 emits an Frequency Modulated Continuous Wave (FMCW) signal via a single transmit antenna (TX1) and continuously receives the radar return signals from the obstacles in the radar's field of view (FOV) via K receive antennas (shown as RX1, RX2, RX3 in FIG. 9.1). The transmitted signals are frequency modulated in smooth, sawtooth fashion as shown in FIG. 8. Step 705 also initializes the controller ODR 321 where position of the parking lots are predefined based on the minimum and maximum boundary parameters of each parking lot. As illustrated above with reference to FIG. 5.2, the boundary parameters of each parking lot (j) consisting of 1) maximum radial distance (Δr₁), (2) minimum radial distance (Δr₂), (3) maximum bearing (Δθ₁), (4) minimum bearing (Δθ₂), (5) maximum vehicle height (Δz₁) and (6) minimum vehicle height (Δz₂). This is predefined for n sectors of each frontend sensor unit 121-125, where n is between 1 and 5. Preferably, n is 4 where the area being monitored is divided into 4 quadrants to form a cylindrical area. This means that the boundary conditions for each of the parking lots within the n sectors of each frontend sensor unit 121-125 are predefined. The boundary conditions for each of the parking lots within the n sectors of each frontend sensor unit 121-125 are predefined manually by a user immediately after installing the frontend sensor to a carpark. Subsequently, the boundary conditions are adjusted by an adaptive algorithm which will be described below with reference to FIG. 10.

In step 710, process 700 captures the time domain data of the return FM chirps. Specifically, the modulated portion is shown as A in FIG. 8 and the received signals are down-converted by K downconverters to obtain K sets of time domain signals I1-Q1, I2-Q2, I3-Q3.

In step 715, process 700 translates the time domain data to frequency domain by applying Fast-Fourier transform (FFT) on the time domain data. Specifically, the time domain data is translated into one set of FFT data. FIG. 9.1 illustrates the received signal 911-913 from the K receive antennas (RX1, RX2, RX3) from one chirp which have been translated into FFT data. As shown in FIG. 9.1, the x-axis is the frequency bin while the y-axis is the amplitude.

In step 725, process 700 stores and accumulates the FFT data. Specifically, step 725 needs to store at least one frame containing L sets of the FFT data in step 715. For purposes of this disclosure, it is observed that 8 sets of FFT data can provide an accurate result.

In step 730, process 700 determines if L consecutive FM chirps have been transmitted by the radar module 311-314. Specifically, process 700 determines the number of chirp count. If chirp count is L, it means that L consecutive chirps from one of the 4 sensor modules 311-314 have been transmitted and process 700 proceeds to step 740. Otherwise, process 700 increments chirp count and repeats from step 710 to capture time domain data of the next return FM chirps from the sensor module 311-314. Essentially, steps 710 to 730 are meant for obtaining FFT data derived from L consecutive FM chirps from one of the 4 sensor modules 311-314 forming 1 frame of FFT data. Hence, each frame contains L sets of the results as shown in FIG. 9.1.

In step 740, process 700 applies a thresholding algorithm to determine the valid peaks from the accumulated FFT data. Specifically, a threshold 921-923 is applied to each of the FFT data to filter away noise. For this invention, constant false alarm rate (CFAR) adaptive thresholding algorithm is implemented in the frequency domain to identify valid targets within the FOV. More specifically, after applying CFAR thresholding, the peaks from the remaining signal are then determined for identifying valid targets.

In step 745, process 700 converts phase and FFT data into range and phases. After FFT is performed on the K receiver outputs in step 715, the complex FFT output gives K sets of amplitude, frequency and phase data. Each set consists of N sequential frequency bins of Fₘₐₓ/N frequency resolution. Each bin represents a range, R, having a resolution of Rₘₐₓ/N. The radial range of obstacles in the radar's field of view presents itself as beat frequencies with the relationship presented in following expressions (1) and (2):

$${f}_{b} = \frac{2 R Δ f}{{c}_{o} T} \qquad ( 1 )$$

$$R = \frac{{c}_{o} T {f}_{b}}{2 Δ f} \qquad ( 2 )$$

Where
R=radial distance between the radar and the target
cₒ=speed of light, 3×10⁸
Δf=frequency bandwidth
T=time needed to modulate the frequency
f_{b}=beat frequency

In step 750, process 700 compares phases of the peaks detected to obtain azimuth and elevation angles. The phases between RX₁ and RX₂, and RX₂ and RX₃ are compared to obtain azimuth and elevation angles respectively. The relationship of the angles and the phase difference between each receive channel is presented in following expression (3):

$$θ = {sin}^{- 1} ( \frac{Δ ϕ λ}{2 π d} ) \qquad ( 3 )$$

Where
θ=bearing of target
ΔØ=phase difference between RXᵢ and RXⱼ
λ=wavelength of transmit frequency in free space
d=distance between RXᵢ and RXⱼ

The cylindrical coordinates (r, θ, z) are obtained where:
r=R which is radial distance between the radar and the target;
azimuth angle=θ which is based on expression 3 where i=1 and j=2
z=r sin θ where θ is based on expression 3 where i=3 and j=2.
Do note that there will be K sets of R, θ and z where R1≈R2≈ . . . . RK and K equates to the number of receivers.

The above is based on the arrangement of the 3 receivers as shown in FIG. 5.1, where RX2 is a reference, RX1 is located laterally to RX2 and RX3 is located longitudinally to RX2. The ΔØ21 between RX2 and RX1 gives the azimuth bearing of the target. The ΔØ32 between RX3 and RX2 gives the elevation bearing of the target to determine the height z.

In step 755, process 700 applies a data clustering algorithm on the cylindrical coordinates which represent the reflected points received from the radar. For purposes of this discussion, process 700 applies a Density-based spatial clustering of applications with noise (DBSCAN). The radar received many reflected points which make up a point cloud. These reflected points in the point cloud are clustered and grouped. Each cluster is given a number for identification. They are then filtered based on a variety of lot parameters (i.e., the ceiling height, vehicle height, floor distance, sensor height, max number of lots per sector, lot type), to identify clusters that are within the lots of interest. As shown in FIG. 9.2, the reflected points on the left of FIG. 9.2 are clustered to form distinct clusters on the right of FIG. 9.2. In the example as show in FIG. 9.2, 6 distinct clusters are formed.

In step 760, process 700 outputs data to the controller ODR1, initialises chirp count, triggers the next sensor module 311-314 to transmit 8 consecutive FM chirps and repeats from step 710. For purposes of this disclosure, assuming 4 sensor modules 311-314 are implemented, each sensor module covers a sector forming 4 quadrants to form a cylindrical shape. Process 700 is repeated for each of the sensor modules 311-314, translating data from each sensor module to distinct clusters in respective sector.

FIG. 10 illustrates a process flow 1000 executed by the instructions store on the memory of the MCU 322 of the detector board 320 to determine vacancy of parking lots scanned by each radar sensor in accordance with an embodiment of this invention. Before process flow 1000 can be executed, we need to first pre-define the 3D space of the parking lots of interest in each sector in the cylindrical coordinates. This can also be known as boundary conditions for each lot. If an ‘x’ number of clusters fall within the boundary condition of sector 1, parking lot 1, we take it as preliminary occupied for that frame and an adaptive algorithm is triggered to check boundary condition for the parking lot 1. It has to be occupied 80% for ‘y’ number of frames before the process updates that the lot is occupied. Similarly, if the parking lot is originally occupied, ‘y’ number of frames has to show unoccupied 80% of the time for an unoccupied update to take place. The boundary conditions are predefined at step 705. It is also useful to note that a sector consists of a quadrant of the surrounding area. Hence, a sensor module can cover 4 quadrants.

Process 1000 begins with step 1005 with retrieving data from the controller. Essentially, the cumulative data from step 760 for all sectors is retrieved for further analysis to determine vacancy. The data are segregated to cluster (z), parking lot (j) and sector (i) where 1<i<5; j refers to parking lot number; and cluster (z) refers to the distinct clusters formed in step 755 of process 700. Using FIG. 6.5, the radar sensor module of the left comprises 4 sectors (i) 611, 612, 613 and 614 for monitoring 12 parking lots (j). Within each sector and parking lot comprises a number of clusters (z) which are formed in step 755 of process 700.

In step 1010, process 1000 selects a cluster from the distinct clusters derived from step 755 in process 700 to compute the average position r_{avgc1}, θ_{avgc1}, z_{avgc1} of that cluster, where avgc refers to average over L chirps. The rᵢ, θᵢ, zᵢ defines a cylindrical coordinate of the selected cluster. Alternatively, process 1000 can also select a cluster (z) data that is relevant to a parking lot (j).

In step 1015, process 1000 compares the average position of the selected cluster with boundary conditions corresponding to the parking lot (j) of a sector (i). The position of each parking lot is defined by (r₁+Δr₁<r_{ref}<r₂+Δr₂, θ₁+Δθ₁<θ_{ref}<θ₂+Δθ₂, z₁+Δz₁<z_{ref}<z₂+Δz₂) where Δr₁=Δr₂=Δθ₁=Δθ₂=Δz₁=Δz₂=0 at the beginning. These are just starting values for the adaptive algorithm. As time passes and the sensor has more occupancy data, the sensor aggregates and averages typical parking positions, which modifies these Δr1, Δr2, Δθ1, Δθ2, Δz1, and Δz2 values as will be discussed below in step 1040. Each cluster of points has points with unique cylindrical coordinates (r_{avgc1}, θ_{avgc1}, z_{avgc1}) and are compared with the pre-defined boundary conditions as above.

In step 1025, if the cylindrical coordinates of the cluster (z) is within the boundary conditions of a parking lot (j) of a sector (i), process 1000 proceeds to step 1030 where the cylindrical coordinates of the cluster (z) data is accumulated and stored in “LotCount”. “LotCount” stores the number of clusters in each parking lot (j) of respective sector (i). If the cylindrical coordinates of the cluster (z) is not within the boundary conditions, process 1000 proceeds to step 1028 where the cylindrical coordinates of the cluster (z) are disregarded and process 1000 repeats from step 1010 for the next cluster.

In step 1035, process 1000 determines if there are more than a predetermined number of clusters in a parking lot (j) of a sector (i). Preferably, the predetermined number of clusters is 3. This means that if 3 or more clusters are in a “LotCount” of a parking lot (j) of sector (i), the parking lot (j) or sector (i) is considered as preliminary occupied and lotOccupancy[i][j] is changed from zero to one and proceeds to step 1040, where [i] refers to sector number and [j] refers to parking lot number. Otherwise, if the “LotCount” of a parking lot (j) of sector (i) is less than the predetermined number, the parking lot (j) or sector (i) is considered as unoccupied and repeats from step 1010 for the next cluster.

In step 1040, process 1000 applies an adaptive algorithm to check boundary conditions of the corresponding parking lot (j) of sector (i) which has been identified as preliminary occupied in step 1035. This is a self-adaptive/self-learning algorithm. From the cluster of points accumulated from step 1030, the algorithm averages cluster position (r_{avgfn}, θ_{avgfn}, z_{avgfn}), with previous values (r_{avgfn-1}, θ_{avgfn-1}, z_{avgfn-1}), to get (r_{avgf}, θ_{avgf}, z_{avgf}), where avgf refers to average over a number of frames, preferably 10 frames. If current average lot position (r_{avgf}, θ_{avgf}, z_{avgf}) is out of reference position (r_{ref}, θ_{ref}, z_{ref}), update (Δr₁, Δr₂, Δθ₁, Δθ₂, Δz₁, Δz₂) with a fixed pre-defined value to shift boundary conditions closer to current average position. If current average lot position (r_{avgf}, θ_{avgf}, z_{avgf}) is within boundary conditions, there is no change for (Δr₁, Δr₂, Δθ₁, Δθ₂, Δz₁, Δz₂), and process 1000 proceeds to step 1045. This adaptive algorithm is executed even before it has determined the lot is occupied in step 1060. This makes the adaptive algorithm more responsive. Rather than wait for 10 frames to make one adjustment, this process adaptively adjusts the lot boundary per frame (i.e., 10× faster). Afterall, it is adjusted only if at least 3 clusters are within the parking lot's boundary.

In step 1045, process 1000 determines if all clusters have been evaluated. If not, process 1000 repeats from step 1015 for the next cluster (z). If all clusters have been evaluated, process 1000 proceeds to step 1050.

In step 1050, process 1000 evaluates lot occupancy information for parking lots in frame (n) and sector (i). For all parking lots (j) in frame (n) and sector (i), if “LotOccupancy(i)(j)=1, increment frameOccupancy(i)(j). This means that [i] refers to sector number and [j] refers to parking lot number, lotOccupancy[i][j] provides the lot occupancy information to frameOccupancy[i][j]. This is accumulated over 10 frames for each parking lot (j) of sector (i).

In step 1055, process 1000 determines if frame count (n) is less than 10. If frame count (n) is less than 10, process 1000 repeats from step 1010 to select cluster (z) from sector number (i) of the next frame count. If frame count (n) is equal or more than 10, process 1000 proceeds to step 1060 to update occupancy for all lots in sector (i). Essentially, steps 1010-1055 are repeated under all 10 frames for each sector number i is being analysed. After all 10 frames for each sector number (i) is being analysed, process 1000 proceeds to step 1060 to evaluate lot occupancy for the lots defined in sector (i).

In step 1060, if process 1000 determines that the lot (j) in sector (i) is occupied if frameOccupancy(i)(j) is equal to or more than a predetermined threshold. For purposes of this invention, the predetermined threshold is 8. This means that if 8 out of 10 frames is occupied, occupancy of lot (j) in sector (i) is indicated as 1 (occupied). Otherwise, occupancy of lot (j) in sector (i) is indicated as zero (not occupied).

After step 1060, process 1000 repeats from step 1005 to retrieve data from the next sector number (i) and resets frameOccupancy(i)(j) to zero.

The above is a description of exemplary embodiments of a system and method in accordance with this disclosure. It is foreseeable that those skilled in the art can and will design alternative devices based on this disclosure.

1. A system for contactless detection and provision on an occupancy status parking lots in at least one vehicle park comprising:
a frontend sensor unit including a plurality of radar modules and a detection board,
each of the radar modules comprises a transmitter configured to transmits L consecutive frequency modulated chirps and at least 3 receivers configured to collect the return chirps; and
the detection board is adapted to control and receive data from each of the radar modules and executing processes to analyse the data received from the radar modules to determine occupancy status of parking lots.

2. The system according to claim 1 wherein the at least 3 receivers are arranged such that the second receiver (RX2) is a reference, the first receiver (RX1) is located laterally to RX2 and the third receiver (RX3) is located longitudinally to RX2.

3. The system according to claim 2 wherein the processes to analyse the data received from the radar modules to determine occupancy status of parking lots comprise instructions to:
initialise the plurality of radar modules;
receive L return chirps from one of the plurality of radar modules;
capture a time domain data of each of the L return chirps;
translate the time domain data of the L return chirps to frequency domain by applying Fast=Fourier transform (FFT) to form one frame of FFT data, each FFT data comprises amplitude, frequency and phase data;
apply a thresholding algorithm to the FFT data to determine valid peaks; and
convert FFT data into ranges and phases.

4. The system according to claim 3 wherein the transmitter is configured to transmit a frequency modulated (FM) chirp over a 2 GHz bandwidth.

5. The system according to claim 4 wherein the processes to analyse the data received from the radar modules to determine occupancy status of parking lots comprise instructions to:
initialize position of each parking lot to determine boundary parameter of the parking lot, the boundary parameter includes maximum and minimum radial distance (r), maximum and minimum bearing (θ) and maximum and minimum vehicle height (z).

6. The system according to claim 5 wherein the one frame of FFT data comprises N sequential frequency bins of Fₘₐₓ/N frequency resolution and each frequency bin represents a range, R, having a resolution of Rₘₐₓ/N and the radial range of obstacles in the radar's field of view presents is a beat frequency with a relationship in a following expression:
$$R = \frac{{c}_{o} T {f}_{b}}{2 Δ f}$$
where R=radial distance between the radar and the target, cₒ=speed of light, 3×10⁸, Δf=frequency bandwidth, T=time needed to modulate the frequency, f_{b}=beat frequency.

7. The system according to claim 6 wherein the processes to analyse the data received from the radar modules to determine occupancy status of parking lots comprise instructions to:
determine cylindrical coordinates (r, θ, z) of each of each FFT data with the following expressions,
r=R;
$$θ = {sin}^{- 1} ( \frac{Δ ϕ λ}{2 π d} )$$
where ΔØ=phase difference between RX1 and RX2, d=distance between RX1 and RX2 and λ=wavelength of transmit frequency in free space; and
$$z = r sin ( {sin}^{- 1} ( \frac{Δ ϕ λ}{2 π d} ) )$$
where ΔØ=phase difference between RX2 and RX3, d=distance between RX2 and RX3 and λ=wavelength of transmit frequency in free space.

8. The system according to claim 7 wherein the processes to analyse the data received from the radar modules to determine occupancy status of parking lots comprise instructions to:
apply a Density-based spatial clustering of applications with noise (DBSCAN) on the cylindrical coordinates to form distinct clusters; and
determine occupancy status of a parking lot if the distinct clusters is within the boundary parameter of the parking lot for a predetermined number of frames.

9. The system according to claim 8 wherein the instruction to determine occupancy status of a parking lot if the distinct clusters is within the boundary parameter of the parking lot for a predetermined number of frames comprises instructions to:
select a cluster from the distinct clusters and compute an average position r_{avgci}, θ_{avgci}, z_{avgci} of the selected cluster, where avgc refers to average over L chirps;
compares the average position of the selected cluster with boundary conditions corresponding to the parking lot of the selected cluster;
in response to the average position of the selected cluster being within the boundary conditions corresponding to the parking lot of the selected cluster, accumulate the cylindrical coordinates of the selected cluster and store in “LotCount” folder where “LotCount” folder contains the number of clusters for the corresponding parking lot; and
in response to the average position of the selected cluster being outside the boundary conditions corresponding to the parking lot of the selected cluster, disregard the cylindrical coordinates of the selected cluster.

10. The system according to claim 9 wherein the instruction to accumulate the cylindrical coordinates of the selected cluster and store in “LotCount” folder where “LotCount” folder contains the number of clusters for the corresponding parking lot further comprises instructions to:
determines if the number of clusters for the corresponding parking lot is more than a predetermined number of clusters;
in response to the number of clusters for the corresponding parking lot being more than a predetermined number of clusters, change a lotOccupancy[i][j] from zero to one and apply an adaptive algorithm to check boundary conditions of the corresponding parking lot, where [i] refers to sector number and [j] refers to parking lot number.

11. The system according to claim 10 wherein the instruction to apply an adaptive algorithm to check boundary conditions of the corresponding parking lot comprises instructions to:
averages the position (r_{avgfn}, θ_{avgfn}, z_{avgfn}) of the selected cluster over a number of frames with previous position (r_{avgfn-1}, θ_{avgfn-1}, z_{avgfn-1}) to obtain a new average position (r_{avgf}, θ_{avgf}, z_{avgf}), where avgf refers to average over a number of frames; and
in response to new average position (r_{avgf}, θ_{avgf}, z_{avgf}) is out of reference position (r_{ref}, θ_{ref}, z_{ref}), update boundary conditions for the corresponding parking lot with a fixed pre-defined value to shift boundary conditions closer to new average position.

12. The system according to claim 11 wherein the instruction to determine occupancy status of a parking lot if the distinct clusters are within the boundary parameter of the parking lot for a predetermined number of frames further comprises instructions to:
evaluate lot occupancy information for the corresponding parking lot each frame (n) and sector (i);
in response to LotOccupancy(i)(j)=1, increment frameOccupancy(i)(j); and
in response to frameOccupancy(i)(j) being is equal to or more than a predetermined threshold, determined parking lot (j) as occupied.

13. The system according to claim 12 wherein the predetermined threshold is 8.
